(19) United States
(12) Patent Application Publication
(10) Pub. No.: US 2022/0297481 A1
(43) Pub. Date: Sep. 22, 2022

(54) PNEUMATIC TIRE

(71) Applicant: The Yokohama Rubber Co., LTD., Tokyo (JP)

(72) Inventor: Kazuya ISHIGURO, Kanagawa (JP)

(21) Appl. No.: 17/754,187

(22) PCT Filed: Sep. 1, 2020
(86) PCT No.: PCT/JP2020/033102

§ 371 Date: Mar. 25, 2022

(30) Foreign Application Priority Data
Sep. 30, 2019 (JP) 2019-178278

(51) Int. Cl. B60C 13/00

(52) U.S. Cl. CPC B60C 13/001

(57) ABSTRACT

A sidewall surface of a pneumatic tire includes a region of a smooth surface and a two-dimensional code within the region and provided with a dot pattern including two types of gray-scale elements formed of surface irregularity with respect to the smooth surface. The tire has a cross-sectional height of 80 mm or less along a radial direction from an innermost position of bead cores in the radial direction to a tire maximum outer diameter position, one or more first ridges projecting with respect to the smooth surface and extending in the radial direction are on a surface of the tire between edges on sides of the two-dimensional code in a circumferential direction and positions away from the edges along the circumferential direction by a length of 50% of the two-dimensional code width, and portions within the range other than the first ridges correspond to the smooth surface.

### TECHNICAL FIELD

The present technology relates to a pneumatic tire and particularly relates to a pneumatic tire including a two-dimensional code on a tire side surface.

### BACKGROUND ART

In recent years, a proposal has been made to provide, on a side surface (sidewall portion) of a pneumatic tire (hereinafter also simply referred to as tire), a two-dimensional code in which information is recorded. The two-dimensional code can include more information than a one-dimensional code. Thus, various information can be included in the two-dimensional code for management of the tire. A technique has been proposed in which the sidewall portion is engraved with a predetermined pattern of dot holes to provide, in the sidewall portion, a two-dimensional code formed of a pattern of gray scale elements (see International Patent Publication No. WO 2005/000714).

When a pneumatic tire provided with such a plurality of dot holes for a two-dimensional code is new, the two-dimensional code can be read. However, in a case where the tire rolls under a load in an outdoor environment, the two-dimensional code may become harder to read. “Reading of a two-dimensional code” refers to reading of a two-dimensional code by a two-dimensional code reader (for example, a mobile terminal), and “decreased readability” refers to an increased frequency of failures in reading. The two-dimensional code provided on the pneumatic tire is utilized by reading the information recorded in the two-dimensional code while the pneumatic tire is in use. Thus, in a case where the tire is used for a long term, cracks may occur and develop in the dot holes of the two-dimensional code to form irregularities on the surface of the two-dimensional code. Then, undesirably, distinction of the gray scale elements becomes difficult, making the two-dimensional code harder to read. Thus, the two-dimensional code is preferably inhibited from becoming harder to read when the tire is used for a long term.

Such a two-dimensional code is preferably provided on a smooth surface of the sidewall portion such that in the initial stage of use of the pneumatic tire, the gray scale elements of the two-dimensional code can be clearly distinguished from one another for advanced readability. The smooth surface is provided with no pattern of surface irregularity and no ridge pattern. Ridge pattern refers to a pattern formed by providing, at regular intervals, ridges having a projection height of 0.2 mm or more and extending linearly.

However, in a pneumatic tire with a tire cross-sectional height of 80 mm or less, the sidewall portion has only a small surface area, and thus there is only a small smooth surface wide enough to include the two-dimensional code disposed thereon, and the smooth surface is limited to a buttress region located in an upper portion of the sidewall portion in the tire radial direction and extending from the tread pattern end. Thus, in a pneumatic tire with a tire cross-sectional height of 80 mm or less, the two-dimensional code is provided on the smooth surface of the buttress region.

However, the buttress region includes a boundary portion between a tread rubber member and a side rubber member, and for a green tire, a slight step is often formed at the boundary portion and is likely to cause vulcanization defects. Vulcanization defects occur as follows. In a case where a green tire is expanded and pressed against an inner surface of a heated vulcanization mold, gas present between the inner surface of the vulcanization mold and the green tire fails to be sufficiently discharged and remains, and the gas hinders contact between the green tire and the inner surface of the vulcanization mold controlled to high temperature, preventing sufficient vulcanization of the green tire. Thus, in the boundary portion with the step, the gas often remains to cause vulcanization defects. Some vulcanization defects form a glossy portion of the surface of the vulcanized tire and can be easily recognized by visual inspection, whereas minor vulcanization defects are difficult to recognize by visual inspection.

Consequently, even in a case where tires with vulcanization defects are eliminated based on visual inspection, not all of the tires with vulcanization defects can be eliminated. Thus, a two-dimensional code may also be provided on portions in which minor vulcanization defects have occurred, which fail to be recognized by visual inspection. In a case where the two-dimensional code is provided in portions in which even minor vulcanization defects have occurred, insufficient vulcanization leads to many cracks formed around the dot holes of the two-dimensional codes due to the use of the tire for a long period of time. More cracks are formed than a case where the two-dimensional code is provided in portions with no vulcanization defects. Thus, the surface irregularity of the two-dimensional code changes, leading to the likelihood of reduction in readability.

It is not preferable that vulcanization defects are present in a region where the two-dimensional code is provided.

### SUMMARY

The present technology provides a pneumatic tire that can suppress occurrence of vulcanization defects in a region in which the two-dimensional code is provided, allowing suppression of decrease in readability of the two-dimensional code despite the use of the tire for a long period of time.

One aspect of the present technology is a pneumatic tire. The pneumatic tire includes:

a pair of bead cores having an annular shape;

a carcass ply having a toroidal shape and wound around the pair of bead cores and provided between the pair of bead cores; and

a pair of side rubber members respectively provided in sidewall portions of the pneumatic tire and covering the carcass ply from an outer side in a tire width direction,

at least one surface of the sidewall portions including a region of a smooth surface and a two-dimensional code located within the region of the smooth surface and provided with a dot pattern including two types of gray scale elements identifiably formed of surface irregularity with respect to the smooth surface,

the pneumatic tire having a cross-sectional height of 80 mm or less along a tire radial direction from an innermost position of each of the pair of bead cores in the tire radial direction to a tire maximum outer diameter position,

one or a plurality of first ridges projecting with respect to the smooth surface and extending in the tire radial direction being provided on a surface of the pneumatic tire within a range between edges on both sides of the two-dimensional code in a tire circumferential direction and positions respectively away from the edges along the tire circumferential direction by a length of 50% of a width of the two-dimensional code along the tire circumferential direction of the pneumatic tire, and portions within the range other than the first ridges corresponding to the smooth surface.

Preferably, the first ridges are two first ridges, and one of the two first ridges is provided on each of both sides of the two-dimensional code in the tire circumferential direction, and the two first ridges are parallel to each other.

Preferably, a separation distance from each of the two first ridges to an edge of the two-dimensional code closest to each of the two first ridges is identical for the two first ridges.

Preferably, the first ridge has a projection height of from 0.3 to 1.0 mm from the smooth surface. More preferably, the projection height is from 0.4 to 0.8 mm.

Preferably, the first ridges are two first ridges, one of the two first ridges is provided on each of both sides of the two-dimensional code in the tire circumferential direction, and two second ridges extending in the tire circumferential direction and respectively connecting ends of the two first ridges on both sides in the tire radial direction are further provided, and

the two-dimensional code is surrounded by the two first ridges and the two second ridges.

Preferably, the two first ridges are parallel to each other.

Preferably, a first separation distance from each of the two first ridges to an edge of the two-dimensional code closest to each of the two first ridges is identical for the two first ridges.

Preferably, a second separation distance from each of the two second ridges to an edge of the two-dimensional code closest to each of the second ridges is identical for the two second ridges.

Preferably, a second separation distance from each of the two second ridges to an edge of the two-dimensional code closest to each of the second ridges is identical for the two second ridges, and the first separation distance is identical to the second separation distance.

Preferably, the two second ridges are provided within a range between edges on both sides of the two-dimensional code in the tire radial direction and positions respectively away from the edges along the tire radial direction by a length of 50% of a length of the two-dimensional code along a surface of the sidewall portion between an edge on an outer side of the two-dimensional code in the tire radial direction and an edge on an inner side of the two-dimensional code in the tire radial direction.

Preferably, a vent hole projection trace is provided at an end of the first ridge in the tire radial direction.

Preferably, a projection height of the first ridge with respect to the smooth surface gradually increases from an end on one side of the first ridge along the tire radial direction, and the vent hole projection trace is provided at one end of both ends of the first ridge in the tire radial direction, the one end of the first ridge having a greater projection height than an other end of the first ridge.

Preferably, a difference in the projection height between the one end and the other end of the first ridge is from 0.2 to 0.5 mm.

The first ridge may straddle a boundary between one side rubber member of the pair of side rubber members and a tread rubber member of the pneumatic tire.

Preferably, the projection height of the second ridge from the smooth surface is from 0.3 to 1.0 mm. More preferably, the projection height is from 0.4 to 0.8 mm.

Preferably, a number of the first ridges provided within the range is two or less.

### BRIEF DESCRIPTION OF DRAWINGS

FIG. 1 is a diagram illustrating an example of a configuration of a pneumatic tire of an embodiment.

FIG. 2 is a diagram illustrating an example of a two-dimensional code provided in a pneumatic tire of an embodiment.

FIG. 3 is a diagram illustrating an example of arrangement of a two-dimensional code and first ridges provided in a pneumatic tire of an embodiment.

FIG. 4 is a diagram illustrating another example of arrangement of a two-dimensional code and first ridges provided in a pneumatic tire of an embodiment.

FIGS. 5A and 5B are diagrams illustrating an example of one end of the first ridge provided in a pneumatic tire of an embodiment.

FIG. 6 is a diagram illustrating an example of arrangement of a two-dimensional code provided in a pneumatic tire of an embodiment.

### DETAILED DESCRIPTION

Hereinafter, a pneumatic tire of the present embodiment will be described in detail.

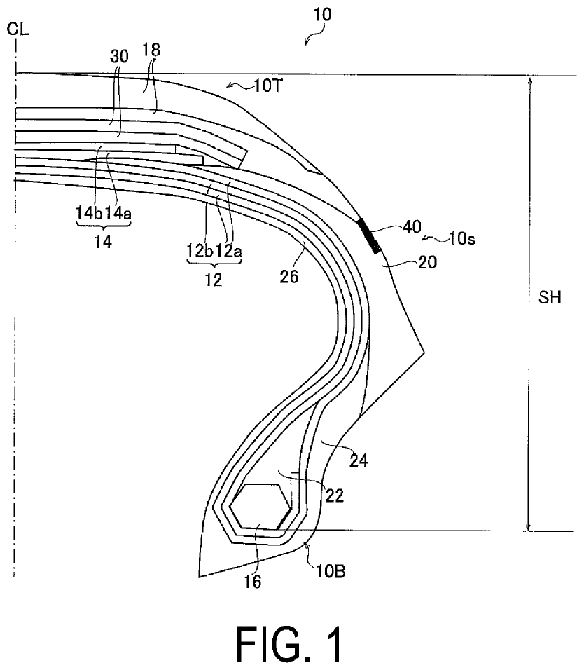

In the present specification. “tire width direction” is a direction parallel with the rotation axis of the pneumatic tire. “Outer side in the tire width direction” is a side in the tire width direction away from a tire equator line CL(see FIG. 1) that represents the tire equatorial plane. “Inner side in the tire width direction” is a side in the tire width direction closer to the tire equator line CL. “Tire circumferential direction” is a direction of rotation with the rotation axis of the pneumatic tire as the center of rotation. “Tire radial direction” is a direction orthogonal to the rotation axis of the pneumatic tire. “Outer side in the tire radial direction” refers to a side away from the rotation axis. Similarly, “inner side in the tire radial direction” refers to a side closer to the rotation axis.

“Tire cross-sectional height SH” and “tire maximum width” described later in the present specification refer to the dimensions measured in an unloaded state in which the tire is assembled on a specified rim and inflated to a specified internal pressure. Here, “specified rim” refers to an “applicable rim” defined by JATMA (The Japan Automobile Tyre Manufacturers Association, Inc.) in a case where the tire complies with JATMA, a “Design Rim” defined by the TRA (The Tire and Rim Association, Inc.) in a case where the tire complies with the TRA, or a “Measuring Rim” defined by the ETRTO (The European Tyre and Rim Technical Organisation) in a case where the tire complies with the ETRTO. Additionally, “specified internal pressure” refers to a “maximum air pressure” defined by JATMA, to the maximum value in “TIRE LOAD LIMITS AT VARIOUS COLD INFLATION PRESSURES” defined by the TRA, or to “INFLATION PRESSURES” defined by the ETRTO.

Note that a two-dimensional code is provided on a side surface (sidewall portion) of a pneumatic tire of an embodiment described below. The two-dimensional code is provided, for example, by engraving. The engraving includes an aspect in which a plurality of minute dot holes are formed on a surface by locally heating and burning the rubber of the sidewall portion by focusing the laser beam on the surface of the sidewall portion and concentrating energy and also includes an aspect in which a two-dimensional code is formed by forming unevenness on the rubber by another means.

The two-dimensional code referred to in the present embodiment is a matrix display-based code including information in two directions, compared to a one-dimensional code (bar code) including information only in the lateral direction. Examples of the two-dimensional code include a QR Code® (trade name), a data matrix (trade name), Maxicode, PDF-417 (trade name), 16K code (trade name), 49 code (trade name), an Aztec code (trade name), an SP code (trade name), a Vericode® (trade name), and a CP code (trade name).

### Pneumatic Tire

FIG. 1 is a diagram illustrating an exemplary configuration of a pneumatic tire 10 (hereinafter simply referred to as “tire 10”) according to one embodiment. FIG. 1 illustrates a profile cross section of one side in the tire width direction with respect to the tire equator line CL.

The tire 10 includes a tread portion 10T including a tread pattern, a pair of bead portions 10B on the respective sides in the tire width direction, and a pair of sidewall portions 10S provided on the respective sides of the tread portion 10T and connected to the pair of bead portions 10B and the tread portion 10T. The tread portion 10T comes into contact with a road surface. The sidewall portions 10S sandwich the tread portion 10T from both sides in the tire width direction. The bead portion 10B is a portion which is connected to the sidewall portion 10S and is located on an inner side of the sidewall portion 10S in the tire radial direction.

The tire 10 includes a carcass ply 12, a belt 14, and a bead core 16 as framework members, and mainly include a tread rubber member 18, side rubber members 20, bead filler rubber members 22, rim cushion rubber members 24, and an innerliner rubber member 26 around the framework members.

The carcass ply 12 includes carcass ply members 12a, 12b that are made of organic fibers covered with rubber and forms a toroidal shape by being wound between a pair of the bead cores 16 having an annular shape. The carcass ply 12 is wound around the bead cores 16 and extends to the outer side in the tire radial direction. The carcass ply 12 includes two carcass ply members 12a, 12b. The carcass ply member 12a is wound around the bead core 16, extends to the outer side in the tire radial direction, and extends to an inner side of the belt 14 in the tire radial direction described below, and the carcass ply member 12b is wound around the bead core 16 and terminates in contact with the bead filler rubber member 22 described below. The belt 14 is provided in an outer side of the carcass ply 12 in the tire radial direction and includes two belt members 14a, 14b. The belt 14 is a member formed of steel cords covered with rubber. The steel cords are inclined at a predetermined angle, for example, from 20 to 300 with respect to the tire circumferential direction. The width of the lower belt member 14a in the tire width direction is greater than the width of the upper belt member 14b in the tire width direction. The steel cords of the two belt members 14a, 14b are inclined in opposite directions. As such, the belt members 14a, 14b are crossing layers serving to suppress expansion of the carcass ply 12 due to the pressure of the air in the tire.

The tread rubber member 18 is provided in an outer side of the belt 14 in the tire radial direction. The side rubber members 20 are connected to both end portions of the tread rubber member 18 and form the side portions 10S. The rim cushion rubber members 24 are respectively provided at inner ends of the side rubber members 20 in the tire radial direction and come into contact with a rim on which the tire 10 is mountable. The bead filler rubber members 22 are provided on an outer side of the bead cores 16 in the tire radial direction and interposed between a portion of the carcass ply 12 before the carcass ply 12 is wound around the bead cores 16 and a portion of the carcass ply 12 after the carcass ply 12 is wound around the bead cores 16. The innerliner rubber member 26 is provided on the inner surface of the tire 10 facing a tire cavity region that is filled with air and is surrounded by the tire 10 and the rim.

Note that the tread rubber member 18 illustrated in FIG. 1 includes a cap tread rubber member located on the outer side in the tire radial direction and a base tread rubber member located on the inner side in the tire radial direction.

In addition, two belt covers 30 made of organic fiber covered with rubber are provided between the belt member 14b and the tread rubber member 18, and the two belt covers 30 cover the belt 14 from the outer side of the belt 14 in the tire radial direction. The belt cover 30 may be provided as needed and is not mandatory. The number of layers of the belt covers 30 is not limited to two and may be one or three.

A two-dimensional code 40 is provided on the surface of the sidewall portion 10S of the tire 10 as described above. In FIG. 1, the two-dimensional code 40 is illustrated with a thick line.

### Two-Dimensional Code

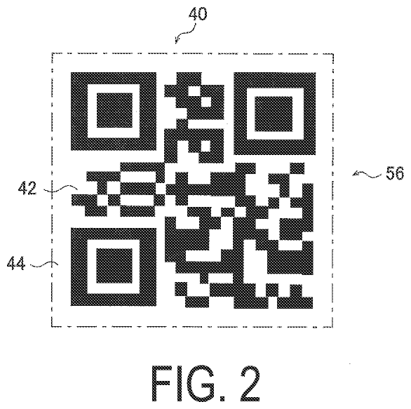

FIG. 2 is a diagram illustrating an example of the two-dimensional code 40 provided on the tire 10 of an embodiment. As illustrated in FIG. 2, the two-dimensional code 40 is provided on a smooth surface 56. The smooth surface 56 is, for example, a surface having an arithmetic mean roughness Ra (JIS B 0601: 2001) of 10 μm to 100 μm. The two-dimensional code 40 as described above is formed on the surface of both the sidewall portions 10S respectively on both sides in the tire width direction. According to another embodiment, the two-dimensional code is formed on the surface of one of the sidewall portions 10S.

The two-dimensional code 40 is formed of a dot pattern made up of two types of gray scale elements distinguishable from each other by surface irregularities. The two-dimensional code 40 of an present embodiment is a pattern formed by focusing laser beams on the surface of the sidewall portion 10S and concentrating energy to locally heat and burn the side rubber member 20, forming a plurality of minute dot holes in the surface thereof. The dot hole is, for example, a conical hole, and the diameter on the tread surface is, for example, from 0.1 to 1.0 mm, and the depth is, for example, from 0.3 to 1.0 mm.

The two-dimensional code 40 is formed by providing one dot hole (recess portion) in one unit cell region of a dark region, of the unit cells that define the gray scale elements of the two-dimensional code. Specifically, the two-dimensional code 40 including a plurality of unit cell regions obtained by division into a lattice-like form and each having a rectangular shape and an identical size has a configuration in which dot holes are arranged such that one dot hole forms one unit cell region with a dark gray scale element. In FIG. 2, the dark region of the unit cell region is represented by a region colored in black.

The two-dimensional code 40 illustrated in FIG. 2 is a QR code @ (trade name) and includes a dot pattern region 42 in which a dot pattern is formed using two types of gray scale elements. A blank region 44 including a pale color element identical to a pale color element of the gray scale elements is provided surrounding the dot pattern region 42. The blank region 44 is illustrated as a region between the edges of the dot pattern region 42 and a rectangular frame delimited by a dot-dash line in FIG. 2. The blank region 44 is known as a quiet zone in a QR Code® (trade name) and required to read the QR Code® (trade name). Preferably, the width over which the blank region 44 surrounds the dot pattern region 42 (the distance dimension between the rectangular frame delimited by the dot-dash line in FIG. 2 and the edges of the dot pattern region 42) is, for example, four to five times as long as the size of each of the unit cell regions in the dot pattern region 42. For example, the width of the blank region 44 is preferably from 4% to 25% of the maximum dimension of the dimensions in two directions of the rectangular shape of the dot pattern region 42.

Since the two-dimensional code 40 illustrated in FIG. 2 is a QR Code® (trade name), the dot pattern region 42 includes data cell regions displaying data cells in the QR Code® (trade name), and finder pattern regions displaying finder patterns.

As described above, since the two-dimensional code 40 is provided on the smooth surface 56, the readability is better than in a case where the two-dimensional code 40 is provided in a ridge pattern region.

The tire 10 provided with the two-dimensional code 40 has a tire cross-sectional height SH of 80 mm or less along the tire radial direction from the innermost position of the bead core 16 in the tire radial direction to the tire maximum outer diameter position. The tire 10 is a low flat tire in which the ratio of the tire cross-sectional height SH to the tire maximum width, at which the tire width in the tire width direction of the tire 10 is greatest, is, for example, 0.4 or less (aspect ratio 40%).

In such tire 10, the sidewall portion 10S has a small area, and the majority of the sidewall portion 10S is often occupied by the ridge pattern region. The smooth surface 56 on which the two-dimensional code 40 may be provided is limited to a buttress region which is close to the pattern end of the sidewall portion 10S. As described above, vulcanization defects are likely to occur in this portion, and with the two-dimensional code 40 provided in a location where vulcanization defects are present, the use of the tire 10 for a long period of time is likely to significantly reduce the readability of the two-dimensional code 40 even if the vulcanization defects are minor.

Thus, in an embodiment, in order to suppress the occurrence of vulcanization defects in a planned arrangement region for the two-dimensional code 40 in a case where the two-dimensional code 40 is provided on the vulcanized tire 10, first ridges 60 described below are provided near the planned arrangement region.

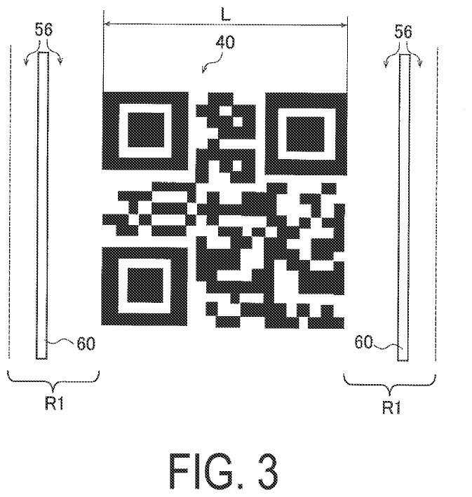

FIG. 3 is a diagram illustrating an example of arrangement of the two-dimensional code 40 and the first ridges 60 provided on the tire 10 of an embodiment.

Specifically, assuming that L is the width of the two-dimensional code 40 along the tire circumferential direction, at least one first ridge 60 projecting with respect to the smooth surface 56 and extending in the tire radial direction is provided on a surface of the tire 10 within a range R1 between edges on both sides of the two-dimensional code 40 in the tire circumferential direction and positions respectively away from the edges along the tire circumferential direction by 50% of the width L (positions indicated by dotted lines in FIG. 3). The portions within the range R1 other than the first ridges 60 correspond to the smooth surface 56. In the example illustrated in FIG. 3, the first ridge 60 is provided on each of both sides of the two-dimensional code 40 in the tire circumferential direction. However, one first ridge 60 may be provided on only one side of the two-dimensional code 40 in the tire circumferential direction. The first ridge 60 provided outside the range R1 does not sufficiently suppress the occurrence of vulcanization defects in the planned arrangement region for the two-dimensional code 40. The arrangement ranges in the tire radial direction in which the first ridges 60 are disposed preferably include the arrangement range in the tire radial direction in which the two-dimensional code 40 is disposed.

Additionally, the number of first ridges provided in one of the ranges R1 is preferably two or less. Three or more of the first ridges reduce the amount of reduction in the occurrence frequency of vulcanization defects compared to two of the first ridges, making the effect of increasing the number of first ridges insufficient.

Note that the first ridge 60 is provided within the range R1 but that as described above, the first ridge 60 is spaced apart from the edge of the two-dimensional code 40 by at least the above-described width of the blank region 44 (see FIG. 2) in order to ensure provision of the blank region 44.

As described above, the surface within the range R1 with respect to the two-dimensional code 40 is provided with one or a plurality of the first ridges 60 extending in the tire radial direction, and the portions other than the first ridge 60 correspond to the smooth surface 56. Thus, as a tire immediately after vulcanization of the green tire with a vulcanization mold, in the tire 10 before provision of the two-dimensional code 40, the surface of the smooth surface 56 within the range R1 with respect to the planned arrangement region for the two-dimensional code 40 is provided with one or the plurality of first ridges 60 extending in the tire radial direction, and the portions other than the first ridges 60 correspond to the smooth surface 56. Even with the plurality of first ridges 60 provided, the plurality of first ridges 60 differ from ridges in a ridge pattern in which three or more ridges are continuously disposed at equal intervals. The first ridges 60 include grooves, corresponding to the first ridges 60, in an inner surface of the vulcanization mold. Accordingly, in a case where the green tire is expanded and contacted with the vulcanization mold for vulcanization, gas present in the gap between the green tire and the inner surface in the planned arrangement region for the two-dimensional code 40 can be made to flow into the grooves provided in the inner surface of the vulcanization mold. This allows suppression of occurrence of vulcanization defects in the planned arrangement region. In a case where the green tire expands and starts contacting the inner surface of the vulcanization mold, the range of contact of the green tire gradually widens from a contact start position along a direction corresponding to the tire radial direction. Thus, the grooves provided in the direction corresponding to the tire radial direction allow the gas in the gap between the green tire and the inner surface to efficiently flow into the grooves.

According to an embodiment, preferably, each one of the two first ridges 60 is provided on each of both sides of the two two-dimensional code 40 in the tire circumferential direction, and the two first ridges 60 are parallel to each other, and furthermore, the separation distance from each of the first ridges 60 to the edge of the two-dimensional code 40 closest to each of the first ridges 60 is identical for the two first ridges 60. Thus, in a case where vulcanization is performed using the vulcanization mold, a flow of the gas present between the green tire and the inner surface of the vulcanization mold in the planned arrangement region for the two-dimensional code 40 can be similarly formed on both sides of the planned arrangement region in the tire circumferential direction, reducing the bias of occurrence of vulcanization defects.

Note that the projection height of the first ridge 60 from the smooth surface 56 is preferably 0.3 to 1.0 mm. When the projection height is less than 0.3 mm, the first ridges are less effective in causing the gas to flow from the planned arrangement region for the two-dimensional code 40 into the grooves, and do not sufficiently suppress the occurrence of vulcanization defects. When the projection height is greater than 1.0 mm, a rubber flow caused by the grooves during vulcanization is non-negligible and is likely to cause appearance defects. Preferably, the projection height is, for example, from 0.4 to 0.8 mm.

The width of the first ridge 60 is not particularly limited, but is, for example, from 0.5 mm to 4.0 mm. When the width is less than 0.5 mm, the first ridges are less effective in causing the gas to flow from the planned arrangement region for the two-dimensional code 40 into the grooves, not sufficiently suppressing the occurrence of vulcanization defects. When the width is greater than 4.0 mm, a rubber flow caused by the grooves during vulcanization is non-negligible and is likely to cause appearance defects.

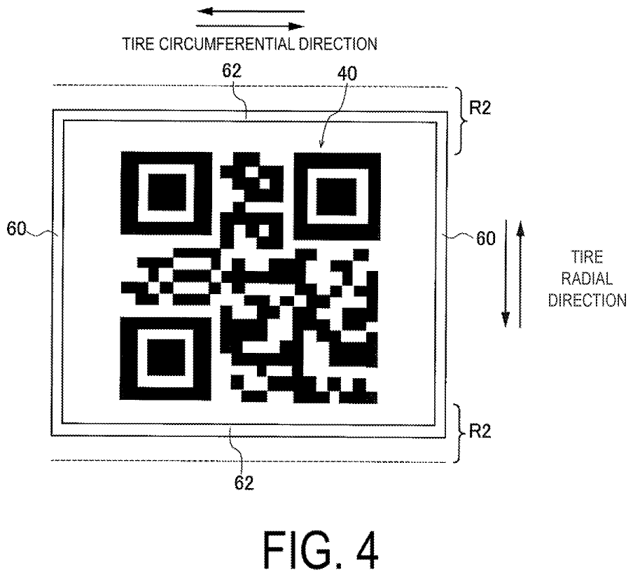

FIG. 4 is a diagram illustrating another example of arrangement of the two-dimensional code 40 and the first ridges 60 provided in the tire 10 of an embodiment.

Two first ridges 60 are provided on both sides of the two-dimensional code 40 illustrated in FIG. 4 in the tire circumferential direction, and two second ridges 62 extending in the tire circumferential direction are provided to respectively connect the ends of the two first ridges 60 on both sides in the tire radial direction. The two-dimensional code 40 is surrounded on all four sides by the first ridges 60 and the second ridges 62.

According to an embodiment, preferably, the two second ridges 62 are also parallel to each other, and furthermore, the separation distance from each of the second ridges 62 of the two second ridges 62 to the edge of the two-dimensional code 40 closest to each of the second ridges 62 is identical for the two second ridges 62.

According to an embodiment, the two first ridges 60 are parallel to each other, the two second ridges 62 are also parallel to each other, and a first separation distance from each of the two first ridges 60 to the edge of the two-dimensional code 40 closest to each of the first ridges 60 is identical for the two first ridges 60, and furthermore, a second separation distance from each of the two second ridges 62 to the edge of the two-dimensional code 40 closest to each of the second ridges 62 is identical for the two second ridges 62. Thus, in a case where vulcanization is performed using the vulcanization mold, a flow of the gas present between the green tire and the inner surface of the vulcanization mold in the planned arrangement region for the two-dimensional code 40 can be similarly formed on both sides of the planned arrangement region in the tire circumferential direction and the tire radial direction, reducing the bias of the occurrence of vulcanization defects. In this case, particularly preferably, the first separation distance is identical to the second separation distance. The gas present between the green tire and the inner surface of the vulcanization mold can be made to flow uniformly, allowing the occurrence of vulcanization defects to be more effectively suppressed.

As described above, the second ridges 62 are provided on an outer side and an inner side of the two-dimensional codes 40 in the tire radial direction, and thus, in a case where the green tire is expanded and contacted with the vulcanization mold for vulcanization, the gas present in the gap between the green tire and the inner surface of the vulcanization mold in the planned arrangement region for the two-dimensional code 40 can be made to flow into the grooves provided in the inner surface of the vulcanization mold. This increases the degree of suppression of occurrence of vulcanization defects in the planned arrangement region.

Note that the projection height of the second ridge 62 from the smooth surface 56 is preferably from 0.3 to 1.0 mm from the same reason as that for the first ridge 60. Preferably, the projection height of the second ridge 62 is, for example, from 0.4 to 0.8 mm.

Additionally, according to an embodiment, the second ridge 62 is preferably provided within a range R2 (see FIG. 4) between edges on both sides of the two-dimensional code 40 in the tire radial direction and positions respectively away from the edges along the tire radial direction by a length of 50% of the length of the two-dimensional code 40 along the surface of the sidewall portion 10S between the edge on an outer side of the two-dimensional code 40 in the tire radial direction and the edge on an inner side of the two-dimensional code 40 in the tire radial direction. Providing the second ridge 62 within the range R2 allows more effective suppression of occurrence of vulcanization defects in the planned arrangement region for the two-dimensional codes 40.

Note that the second ridge 62 is provided within the range R2 but that as described above, the second ridge 62 is spaced apart from the edge of the two dimensional code 40 by at least the above-described width of the blank region 44 in order to ensure provision of the blank region 44 (see FIG. 2).

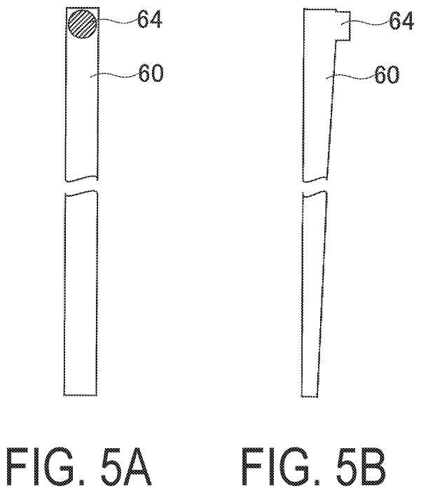

FIG. 5A is a diagram illustrating an example of one end of the first ridge 60. As illustrated in FIG. 5A, a vent hole projection trace 64 is provided at one end of the first ridge 60 in the tire radial direction. The vent hole projection trace 64 is a portion that projects slightly from the top portion of the first ridge 60. Specifically, the vent hole projection trace 64 is a trace of a vent hole projection formed on the tire 10 immediately after vulcanization and cut near a projection base portion. A vent hole is a gas discharge hole provided in the vulcanization mold, and has a function to discharge the gas present between the green tire and the inner surface of the vulcanization mold to the outside of the vulcanization mold. The vent hole projection is a whisker-like projection formed by flow of excess rubber and the like into the vent hole used as a gas discharge hole after discharge of the gas to the outside, and is also referred to as a spew. Consequently, the vent hole projection trace 64 signifies that, in the vulcanization mold, a vent hole is formed in the groove bottom of the end of the groove corresponding to the first ridge 60. Thus, in such a vulcanization mold, the gas present between the green tire and the inner surface of the vulcanization mold in the planned arrangement region for the two-dimensional codes 40 can be discharged to the outside of the vulcanization mold via the vent hole. This further reduces the occurrence frequency of vulcanization defects in the planned arrangement region for the two-dimensional code 40. Note that the vent hole projection trace 64 may be provided at both ends of the first ridge 60. The outer diameter of the vent hole projection trace 64 is preferably 2.0 to 4.0 mm, for example.

FIG. 5B is a diagram illustrating an example of one end of the first ridge 60.

According to an embodiment, as illustrated in FIG. 5B, in a case where the projection height of the first ridge 60 with respect to the smooth surface 56 gradually increases from an end on one side along the tire radial direction, the vent hole projection trace 64 is preferably provided at one end of both ends of the first ridge 60 in the tire radial direction, the one end having a greater projection height than the other end of the first ridge 60 in the tire radial direction. In such a configuration, in the vulcanization mold, the groove depth of the groove provided in the vulcanization mold corresponding to the first ridge 60 gradually increases along the direction corresponding to the tire radial direction, and a vent hole is formed at the end with a greater groove depth. Accordingly, in such a vulcanization mold, the gas flowing into the grooves can be made to flow toward the end with the greater groove depth and can be discharged from the vent hole provided on the end with the greater groove depth to the outside of the vulcanization mold. This further reduces the occurrence frequency of vulcanization defects in the planned arrangement region for the two-dimensional code 40. The difference in the projection height between one end and the other end of the first ridge 60 is, for example, from 0.2 to 0.5 mm. The projection height may vary linearly or in a curved manner.

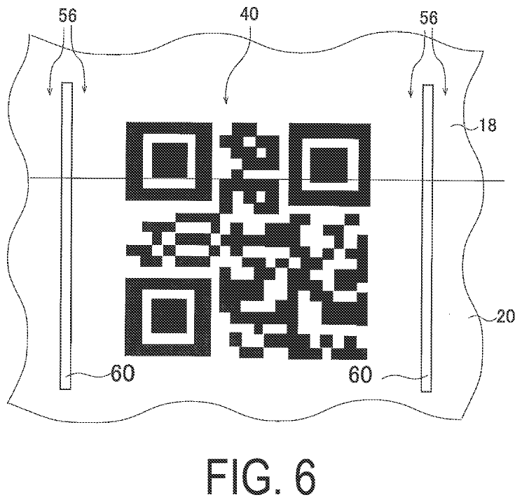

FIG. 6 is a diagram illustrating an example of arrangement of the two-dimensional code 40 provided on the tire 10 of an embodiment. As described above, in the tire 10 having a tire cross-sectional height SH of80 mm or less, the smooth surface 56 in which the planned arrangement region for the two-dimensional code 40 is set is limited to at least the buttress region in the sidewall portion 10S. As illustrated in FIG. 6, the buttress region includes a boundary portion between the tread rubber member 18 and the side rubber member 20. As described above, the boundary portion often includes a step that is likely to cause vulcanization defects in the green tire. However, the first ridge 60 is provided straddling the boundary portion of the tread rubber member 18 and the side rubber member 20, the boundary portion being susceptible to vulcanization defects. Thus, even in a case where the planned arrangement region for the two-dimensional code 40 is set straddling the boundary portion, the occurrence of vulcanization defects in the planned arrangement region can be suppressed.

### Examples, Comparative Example

In order to confirm the effect of the tire 10, tires (tire size of 295/25ZR21 (96Y)) were manufactured in which the two-dimensional code 40, specifically, a QR Code® (trade name) was engraved straddling the boundary portion between the side rubber member in the buttress region of the sidewall portion 10S and the tread rubber member. The tire cross-sectional height SH (mm) is 72 mm. The manufactured tires were mounted on 21×10.5 J rims. After the tire was irradiated with ozone concentration of 100 pphm, indoor drum running (speed 120 km/h) was performed for 1.5 hours by a low-pressure test (XL: air pressure 160 kPa, load 100% LI) in accordance with FMVSS (Federal Motor Vehicle Safety Standards) 139, while the tire was irradiated with the ozone concentration at predetermined time intervals. This test is a simulation of tire deterioration due to use of the tires for a long period of time.

The two-dimensional code 40 was provided on ten tires in each of Examples and Comparative Example, and the test described above was conducted. After the test described above was conducted, the two dimensional code 40 was read.

A two-dimensional code reader was used to read the two-dimensional code 40. The two-dimensional code 40 was irradiated with predetermined illumination light from predetermined directions (ten directions) to read the two-dimensional code 40 from the ten tires, and the ratio of the number of correct readings of the two-dimensional code 40 to the number of readings of the two-dimensional codes 40 was determined as a reading success rate.

In each case, the reading success rate determined was lower than the reading success rate at the beginning of use of the tires, and for the reduced reading success rates, the reading success rates in Examples were expressed as index values, with the reading success rate in Comparative Example with no first ridges 60 being assigned the value of 100. The index values were used as readability evaluation results for the use of the tires for a long period of time.

Tables 1 and 2 indicate the evaluation results.

In the Tables 1 and 2 described below, the two-dimensional code 40 is engraved with a QR Code® (trade name) in which the dot hole has a depth of 1.5 mm and in which square unit cells defining the gray scale elements each have a length of 0.6 mm. The first ridges 60 and the second ridges 62 have a projection height of 0.5 mm or from 0.3 to 0.8 mm and a width of 0.6 mm. The vent hole projection trace 64 has an outer diameter of 0.5 mm. In a case where the first ridge 60 was provided, the center position of the width of the first ridge 60 was located at a position away from the edge of the two-dimensional code 40 by 30% of the width of the two-dimensional code 40 in the tire circumferential direction. In a case where the second ridge 62 was provided, the center position of the width of the second ridge 62 was located at a position away from the edge of the two-dimensional code 40 by 30% of the length along the surface of the sidewall portion 10S between the edge on the outer side of the second ridge 62 in the tire radial direction and the edge on the inner side of the second ridge 62 in the tire radial direction.

In Tables 1, 2, “Provided on one side” means that the first ridge 60 is provided on one side of the two-dimensional code 40 in the tire circumferential direction, and “Provided on both sides” means that the first ridge 60 is provided on both sides of the two-dimensional code 40 in the tire circumferential direction.

Additionally, “Provided on outer side in tire radial direction” means that the second ridge 62 is provided on the outer side of the two-dimensional code 40 in the tire radial direction, and “Provided on inner side and outer side in tire radial direction” means that the second ridges 62 are provided on the inner side and the outer side of the two-dimensional codes 40 in the tire radial direction.

In Example 6, “Provided at end on one side” means that the vent hole projection trace 64 is provided at the end with a greater projection height. The end on the outer side in the tire radial direction has a greater projection height than the end on the inner side in the tire radial direction.

In Example 5, the first ridges 60 have a constant projection height, and the vent hole projection trace 64 was provided at the end on the outer side in the tire radial direction.

TABLE 1

| | Comparative | | | |
|---|---|---|---|---|
| | Example | Example 1 | Example 2 | Example 3 |
| Presence of | No | Provided on | Provided on | Provided on |
| first ridge | | one side | both sides | both sides |
| | | (Projection | (Projection | (Projection |
| | | height of 0.5 | height of | height of 0.5 |
| | | mm) | 0.5 mm) | mm) |
| Presence of | No | No | No | Provided on |
| second ridge | | | | outer side in tire |
| | | | | radial direction |
| | | | | (Projection |
| | | | | height of 0.5 |
| | | | | mm) |
| Presence of | — | No | No | No |
| vent hole | | | | |
| projection | | | | |
| trace | | | | |
| Presence of | — | No change | No change | No change |
| change in | | | | |
| projection | | | | |
| height of first | | | | |
| ridge | | | | |
| Readability | 1.00 | 103 | 105 | 106 |

TABLE 2

| | Example 4 | Example 5 | Example 6 |
|---|---|---|---|
| Presence of | Provided on both | Provided on both | Provided on both |
| first ridge | sides | sides | sides |
| | (Projection height | (Projection height | (Projection height |
| | of 0.5 mm) | of 0.5 mm) | of 0.5 mm) |
| Presence of | Provided on inner | Provided on inner | Provided on inner |
| second ridge | side and outer side | side and outer side | side and outer side |
| | in tire radial | in tire radial | in tire radial |
| | direction | direction | direction |
| | (Projection height | (Projection height of | (Projection height |
| | of 0.5 mm) | 0.5 mm) | of 0.5 mm) |
| Presence of | No | Provided at end on | Provided at end on |
| vent hole | | one side | one side |
| projection | | | |
| trace | | | |
| Presence of | No change | No change | Change occurred |
| change in | | | (Projection height |
| projection | | | of 0.3 mm → 0.8 |
| height of | | | mm) |
| first ridge | | | |
| Readability | 107 | 109 | 111 |

In all examples, readability was reduced compared to the readability at the beginning of use of the tires, but Table 1 indicates that provision of at least one first ridge 60 within the range R1 suppresses reduction in the readability of the two-dimensional code 40 when used for a long period of time compared to a configuration with no first ridges 60. Additionally, Tables 1, 2 indicate that reduction in the readability of the two-dimensional code 40 when the tires are used for a long period of time is suppressed in a case where the second ridge 62 extending in the tire circumferential direction is provided within the range R2, in a case where the vent hole projection trace 64 is present at an end of the first ridge 60, or in a case where the projection height of the first ridge 60 is gradually increased such that the vent hole projection trace 64 is present at the end of the first ridge 60 on the side with a greater projection height.

The foregoing has been a detailed description of the pneumatic tire according to embodiments of the present technology. However, the present technology is naturally not limited to the above embodiments and Examples, and may be improved or modified in various ways within the scope of the present technology.

1-16. (canceled)

17. A pneumatic tire comprising:
a pair of bead cores having an annular shape;
a carcass ply having a toroidal shape and wound around the pair of bead cores and provided between the pair of bead cores; and
a pair of side rubber members respectively provided in side surfaces of the pneumatic tire and covering the carcass ply from an outer side in a tire width direction,
at least one surface of the side surfaces comprising a region of a smooth surface and a two-dimensional code located within the region of the smooth surface and provided with a dot pattern comprising two types of gray scale elements identifiably formed of surface irregularity with respect to the smooth surface,
the pneumatic tire having a cross-sectional height of 80 mm or less along a tire radial direction from an innermost position of each of the pair of bead cores in the tire radial direction to a tire maximum outer diameter position,
one or a plurality of first ridges projecting with respect to the smooth surface and extending in the tire radial direction being provided on a surface of the pneumatic tire within a range between edges on both sides of the two-dimensional code in a tire circumferential direction and positions respectively away from the edges along the tire circumferential direction by a length of 50% of a width of the two-dimensional code along the tire circumferential direction of the pneumatic tire, and portions within the range other than the first ridges corresponding to the smooth surface.

18. The pneumatic tire according to claim 17, wherein
the first ridges are two first ridges,
one of the two first ridges is provided on each of both sides of the two-dimensional code in the tire circumferential direction, and
the two first ridges are parallel to each other.

19. The pneumatic tire according to claim 18, wherein
a separation distance from each of the two first ridges to an edge of the two-dimensional code closest to each of the two first ridges is identical for the two first ridges.

20. The pneumatic tire according to claim 17, wherein
the first ridge has a projection height of from 0.3 to 1.0 mm from the smooth surface.

21. The pneumatic tire according to claim 17, wherein
the first ridges are two first ridges,
one of the two first ridges is provided on each of both sides of the two-dimensional code in the tire circumferential direction, and two second ridges extending in the tire circumferential direction and respectively connecting ends of the two first ridges on both sides in the tire radial direction are further provided, and
the two-dimensional code is surrounded by the two first ridges and the two second ridges.

22. The pneumatic tire according to claim 21, wherein
the two first ridges are parallel to each other.

23. The pneumatic tire according to claim 21, wherein
a first separation distance from each of the two first ridges to an edge of the two-dimensional code closest to each of the two first ridges is identical for the two first ridges.

24. The pneumatic tire according to claim 21, wherein
a second separation distance from each of the two second ridges to an edge of the two-dimensional code closest to each of the two second ridges is identical for the two second ridges.

25. The pneumatic tire of claim 23, wherein
a second separation distance from each of the two second ridges to an edge of the two-dimensional code closest to each of the two second ridges is identical for the two second ridges, and
the first separation distance is identical to the second separation distance.

26. The pneumatic tire according to claim 21, wherein
the two second ridges are provided within a range between edges on both sides of the two-dimensional code in the tire radial direction and positions respectively away from the edges along the tire radial direction by a length of 50% of a length of the two-dimensional code along the side surface between an edge on an outer side of the two-dimensional code in the tire radial direction and an edge on an inner side of the two-dimensional code in the tire radial direction.

27. The pneumatic tire according to claim 21, wherein
the two second ridges have a projection height of from 0.3 to 1.0 mm from the smooth surface.

28. The pneumatic tire according to claim 17, wherein
a vent hole projection trace is provided at an end of the first ridge in the tire radial direction.

29. The pneumatic tire according to claim 28, wherein
a projection height of the first ridge with respect to the smooth surface gradually increases from an end on one side of the first ridge in the tire radial direction, and the vent hole projection trace is provided at one end of both ends of the first ridge in the tire radial direction, the one end of the first ridge having a greater projection height than an other end of the first ridge.

30. The pneumatic tire according to claim 29, wherein
a difference in the projection height between the one end and the other end of the first ridge is from 0.2 to 0.5 mm.

31. The pneumatic tire according to claim 17, wherein
the first ridge is provided straddling a boundary between one side rubber member of the pair of side rubber members and a tread rubber member of the pneumatic tire.

32. The pneumatic tire according to claim 17, wherein
a number of the first ridges provided within the range is two or less.
